(19) United States
(12) Patent Application Publication
(10) Pub. No.: US 2026/0312922 A1
(43) Pub. Date: Oct. 8, 2026

(54) BUFFERING PACKETS TO MANAGE TIME DELAYS IN A BONDED DATA CONNECTION

(71) Applicant: Connectify, Inc., Philadelphia, PA (US)

(72) Inventors: Alexander Gizis, Philadelphia, PA (US); Kevin Cunningham, Swarthmore, PA (US); Brian Prodoehl, Plymouth Meeting, PA (US)

(21) Appl. No.: 19/640,095

(22) Filed: Apr. 6, 2026

Related U.S. Application Data
(60) Provisional application No. 63/785,240, filed on Apr. 8, 2025.

(51) Int. Cl. H04L 49/9005; H04L 12/46

(52) U.S. Cl. CPC H04L 49/9005; H04L 12/4641

(57) ABSTRACT

One example may include transmitting and receiving packets between a client device and a virtual private network (VPN) server over communication channels, measuring packet delays based on times associated with the received packets for each of the communication channels over a period of time, creating a time delay based on the measured packet delays, bonding the plurality of communication channels together to form a single data connection, and applying the time delay to subsequently received packets for one or more of the plurality of communication channels causing each of the subsequently received packets to be delivered to a client device with a same time duration between each packet.

### TECHNICAL FIELD

This application relates to data management and more particularly to managing data communications by buffering data packets.

### BACKGROUND

Client devices may be identified as being operable at a particular source and location and having specific attributes, such as a hardware device profile, an assigned IP address, an assigned network, etc. The use of client devices to perform various data access operations can be prohibited or at least limited by the settings and restrictions of the remote data sources that are being accessed by the client devices. For example, a client device may be attempting to access a secure and popular server for secure information, such as streaming content, secure order information, access to a protected account, etc.

A virtual private network (VPN) server is a tool that can offer an alternative to a client device's normal network data traffic. Generally, a VPN server may use different network routes and perform encapsulation and/or encryption among other data management operations. When client devices are experiencing degradation in one or more data metrics, such as packet loss, data rate, latency and jitter, certain changes may be made to respective data connections and channels to ensure data integrity to preserve the use of real time applications and other applications which may require a certain level of data integrity.

### SUMMARY

This application relates to data management and more particularly to managing data communications by buffering data packets. One example process may include transmitting and receiving packets between a client device and a virtual private network (VPN) server over a plurality of communication channels, measuring packet delays based on times associated with the received packets for each of the plurality of communication channels over a period of time, creating a time delay based on the measured packet delays, bonding the plurality of communication channels together to form a single data connection, and applying the time delay to subsequently received packets for one or more of the plurality of communication channels causing each of the subsequently received packets to be delivered to a client device with a same time duration between each packet.

Another example embodiment may include an apparatus a processor configured to transmit and receive packets associated with a virtual private network (VPN) server over a plurality of communication channels, measure packet delays based on times associated with the received packets for each of the plurality of communication channels over a period of time, create a time delay based on the measured packet delays, bond the plurality of communication channels together to form a single data connection, and apply the time delay to subsequently received packets for one or more of the plurality of communication channels causing each of the subsequently received packets to be delivered with a same time duration between each packet.

Another example embodiment may include transmitting and receiving packets between a client device and a virtual private network (VPN) server over a plurality of communication channels, measuring packet delays based on times associated with the received packets for each of the plurality of communication channels over a period of time, creating a time delay based on the measured packet delays, bonding the plurality of communication channels together to form a single data connection, and applying the time delay to subsequently received packets for one or more of the plurality of communication channels causing each of the subsequently received packets to be delivered to a client device with a same time duration between each packet.

### BRIEF DESCRIPTION OF THE DRAWINGS

FIG. 1A illustrates a communication network used to support data management of client devices according to example embodiments.

FIG. 1B illustrates a communication network utilizing artificial intelligence to support data management services for a client device according to example embodiments.

FIG. 2A illustrates a VPN server monitoring packet data metrics for a client device transmitting and receiving data according to example embodiments.

FIG. 2B illustrates a VPN server identifying varying time delays for packet data of different data channels associated with a client device transmitting and receiving data according to example embodiments.

FIG. 2C illustrates a VPN server transmitting and receiving various different packet data streams from various different data channels and identifying varying packet data metrics according to example embodiments.

FIG. 2D illustrates a VPN server applying one or more time delays to various different packet data streams based on the identified packet data metrics according to example embodiments.

FIG. 3 illustrates an example flow diagram of an example data management process according to example embodiments.

FIG. 4 illustrates a system configuration for storing and executing instructions for any of the example processes according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments may be referred to with reference to a communication ‘session’. The term ‘session’ may be a communication data link between a ‘client’ (computing device, smartphone, computer, etc.) and ‘server’ (content server, virtual private network server, destination server, etc.) or any two or more network-based entities in communication across a data communication network. A session may be based on a single communication link or channel or multiple links or channels. Examples of multiple channels being used in a session may be based on multiple network interface devices (i.e., network interface cards (NICs)) being used in a single session, and/or multiple TCP/UDP sockets being created in a single session among other device resources. Multiple transport connections which are established via TCP and/or UDP may also be considered a session. Additionally, encryption that is used for the session may be independently established to include a unique key for each transport connection and/or channel established for the session. The session encryption may instead be a single key encryption used to encrypt all the communication exchanges during the session. In general, most transport connections are encrypted independently. All of the described examples of a session may be adapted to include one or more alternatives or combinations thereof. Each session may be subjected to multiple different communication mediums providing a variety of one or more channels, transports, radio links, physical links, network interface cards and wireless and/or wired connections.

Network connection optimization for an application server provides data network access through communication channels to one or more client devices. Data communication protocols may include one or more of a transmission control protocol (TCP) and/or a user datagram protocol (UDP). Also, the TCP/IP protocol suite enables the determination of how a specific device should be connected to the Internet and how data can be exchanged by enabling a virtual network when multiple network devices are connected. TCP/IP stands for transmission control protocol/Internet protocol and it is specifically designed as a model to offer reliable data byte streams over various interconnected data networks.

UDP is a datagram/packet oriented protocol used for broadcast and multicast types of network transmissions. The UDP protocol may work similar to TCP, but with some of the error-checking criteria removed which reduces the amount of back-and-forth communication and deliverability requirements.

TCP is a connection-oriented protocol and UDP is a connectionless protocol. The speeds (data rates) associated with TCP are generally slower than UDP, while the speed of UDP is generally faster within the network with regard to sending data across a network. TCP uses a ‘handshake’ protocol such as ‘SYN’, ‘SYN-ACK’, ‘ACK’, etc., while UDP uses no handshake protocols. TCP performs error checking and error recovery, and UDP performs error checking, but discards erroneous packets. TCP employs acknowledgment segments, but UDP does not have any acknowledgment segment.

A TCP connection is established with a three-way handshake, which is a process of initiating and acknowledging a connection. Once the connection is established, data transfer begins and when the transmission process is finished the connection is terminated by the closing of an established virtual circuit. UDP uses a simple transmission approach without implied hand-shaking requirements for ordering, reliability, or data integrity. UDP also disregards error checking and correction efforts to avoid the overhead of such processing efforts at the network interface level, and is also compatible with packet broadcasts and multicasting.

TCP reads data as streams of bytes, and the message is transmitted to segment boundaries. UDP messages contain packets that were sent one by one. It also checks for integrity at the arrival time. TCP messages move across the Internet from one computer to another. It is not connection-based, so one program can send lots of packets to another. TCP rearranges data packets in a specific order. UDP protocol has no fixed order because all the packets are independent of each other. The speed for TCP is slower and UDP is faster since error recovery is omitted from UDP. The header sizes are 20 bytes and 8 bytes for TCP and UDP, respectively.

In general, TCP requires three packets to set up a socket connection before any user data can be sent. UDP does not require three packets for socket setup. TCP performs error checking and also error recovery and UDP performs error checking, but discards erroneous packets. TCP is reliable as it guarantees delivery of data to the destination router. The delivery of data to the destination is not guaranteed by UDP. UDP is ideal to use with multimedia such as voice over IP (VoIP) since minimizing delays is critical. TCP sockets should be used when both the client and the server independently send packets and an occasional delay is acceptable. UDP should be used if both the client and the server separately send packets, and an occasional delay is not acceptable.

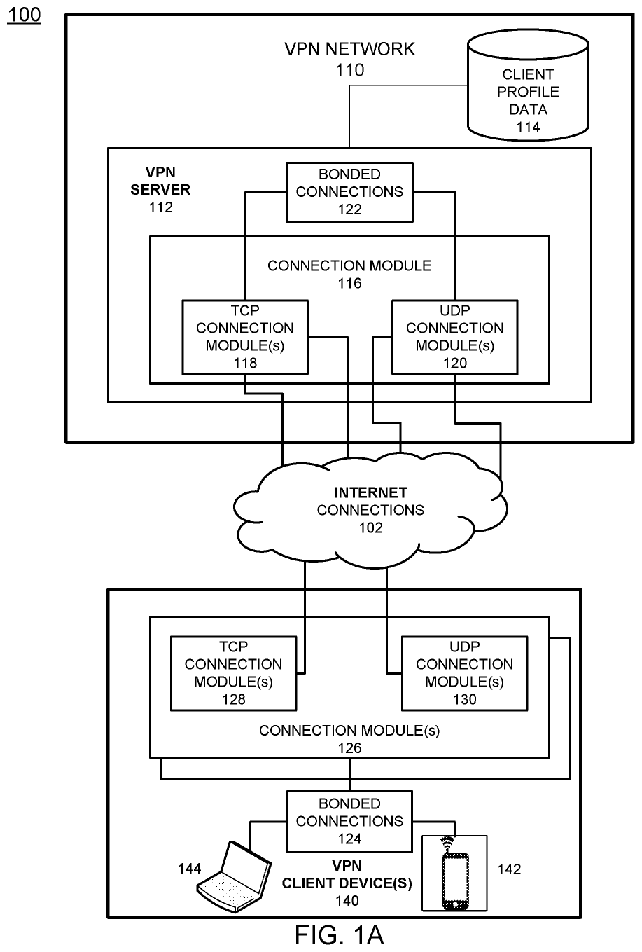

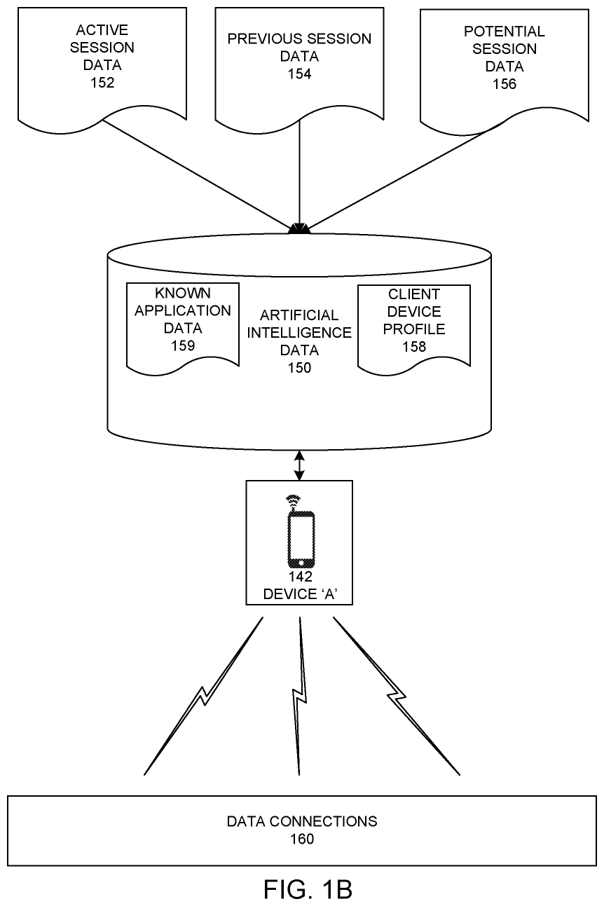

FIG. 1A illustrates an example data session network configuration according to example embodiments. Referring to FIG. 1A, the configuration 100 may include a virtual private network (VPN) 110 which includes one or more VPN servers 112 and data storage, which in this case is used for storing at least client profile data 114 associated with one or more new or old client communication sessions. The term ‘VPN’ may represent one or more servers designated to perform the VPN functionality. The communication sessions may include multiple network channels, generally, UDP and TCP are used for such sessions, however, other protocols used across the Internet 102 may also be used, such as HTTPS. The channels may be bonded together to create a single virtual channel for communication as shown from the bonded connections module 122 for the VPN server 112 and the bonded connections module 124 of the client device 140. In general, the VPN 112 may include UDP module(s) 120 and a TCP module(s) 118 as part of a connection module 116 to manage the connection process and a bonded connections module 122 to manage the various channels and the bonding of information among the channels.

The client side may include one or more client devices 140 such as a smartphone 142, cell phone, tablet, laptop 144, etc. Any one of those individual devices may be the ‘client device’ 140 at any particular time for a particular session. The client side may have an installed agent software application that communicates with the cloud servers of the VPN network 110. The communications are established and maintained across the Internet 102. The client side may also have its own bonded connections module 124 which manages one or more TCP/UDP connections associated with TCP/UDP connection modules 128/130, each of which may have multiple modules to accommodate multiple session, as part of the connection module(s) 126 of the client side. The connection module 126 may be multiple modules which are used for multiple respective sessions with various end user devices 140.

In general, a transport connection is a connection between the VPN client and the VPN server over a particular network and/or Internet connection using a particular protocol, such as TCP, UDP, HTTPS, or another protocol. The established connection is used to send encapsulated and/or encrypted application packets between the client and the server. In one example embodiment, multiple transports connections are created for each session over the available networks and protocols. Conventionally, a VPN will create one transport connection over one network with one protocol per session. For example, given two networks to utilize, the data connection optimization application may create three transport connections (e.g., TCP, UDP, and HTTPS) over each network, for a total of six transport connections. Other combinations of connection types, numbers of connections, etc., may also be utilized.

A VPN may be used by any client device participating in a collaboration session (i.e., conference) with other client devices. One device among a plurality of devices may be using a VPN while others are not using any VPN. All of the devices may send data and receive data to and from an application server in a cloud network, however, one or more client devices may use a VPN server as an intermediate/third party device to assist with the data management of that particular client device. One strategy employed by a VPN may include channel management over a single session. For example, multiple channels may exist for a single client device and can be combined into a bonded channel (unique data is sent on more than one channel), a mirrored channel (the same data is sent on more than one channel) or a combination of both. The channel management activities may permit packets to be sent and received faster and/or with fewer errors depending on the strategy employed by the VPN server. The VPN server(s) may have an optimal Internet connection to the application servers in the cloud network, and may use certain fundamental routing strategies to optimize data traffic quality, the VPN could send video data first as prioritized data from certain client devices to the cloud servers as opposed to browser request data, e-mail data, and other types of Internet data. All of these data management strategies and others can be managed by a VPN specific application that is operating on the client devices while the conference or other collaboration application is being utilized. The VPN (client) application may be a background type of application that is not detectable by the user or other applications using Internet data services. The VPN server may also attempt to host its own conference assuming the VPN server offers an application that is managed locally by the VPN server so the client devices which are part of that VPN network can have the VPN server perform additional conference application functions.

Example embodiments may include a system, a method, a device, a non-transitory computer readable medium or any combination of such configurations which provide data services to a client device, such as a mobile device, smartphone, tablet, watch, eyewear, laptop, personal computer (PC) or similar device. When a device is attempting to connect to a network for access to a network of devices, such as a local or remote network (e.g., Internet), the client device 142 may be configured to identify and connect to a number of different networks.

FIG. 1B illustrates a communication network utilizing artificial intelligence to provide data management services to a client device according to example embodiments. Referring to FIG. 1B, the artificial intelligence databank 150 may store data collected from a particular client's data session(s) over time. In one example, a client device 142 may be utilizing one or more data connections which are managed by the VPN server 112. Each time a data connection 160 is made to establish a particular channel over an ISP, a cellular communication network, a Wi-Fi network, etc., the session data may be logged to include any one or more data performance metrics, such as data rates, delay, latency, jitter, packet loss, applications used, etc. Certain application data 159 may be stored, such as which applications were used and their specific data performance metrics while being used.

Each client device may have its own profile 158 identifying connections used, applications used, performance metrics, etc. The AI databank 150 may be used by the VPN server 112 or the VPN client application installed on the device 142 to determine which data connections 160 should be used at any particular time. Over a period of time, the active session data of current data sessions 152, previous session data of past data sessions 154 and available data sources representing potential session data 156 may be weighed to determine which of the available connections 160 should be continued, restored, activated, etc. For example, if a connection is maintained for a threshold period of time, the session data may be logged as baseline session data used to select that same session again or another session via another channel depending on the session requirements of an upcoming data session. In one example, a data session may require a minimum threshold latency rate, data rate, etc. The previous session may have not maintained such parameters and therefore another session may be launched on another channel with the assumption that the previous channel will not satisfy the session data needs. Other considerations for preparing a new data session may be the application(s) used on the previous session and the application(s) being used on the current session. The identification of those applications may enable an automated intelligent decision to be made which mitigates the chances the next session experiences failures or unexpected data disruptions.

In one example, a current data session may include a cellular data channel and/or a Wi-Fi data channel that are being used to provide streaming data to the client device 142 from a remote server location. A client application used to provide optimal VPN data services to the client device may have a VPN server service assigned to the client device 142. The artificial intelligence (AI) data may be used by the VPN server to automatically initiate a time delay for packets intended for the client device 142.

In one example, the AI data 150 available to the VPN server 212 may identify a current latency and/or jitter value for packets received by the client device 142. The decision may then be made by the automated data session controller to maintain a current delay rate or to introduce a delay by buffering the incoming packets intended for the client device by a set amount of time (delay window) intended to be used as a time delay (Td) between each packet forwarded to the client device 142. An initial baseline may be created based on the client device 142 using the VPN server 212 for data services while operating one or more applications for a particular time. The baseline may be stored as a dataset in the AI data store 150. The dataset may include dataset elements including data rates experienced, latency rates, packet loss, jitter, etc. Certain known thresholds may be compared to those dataset elements to determine whether the dataset data is optimal or not optimal.

Over a fixed period of time, the VPN server 212 may determine that one or more elements of the dataset data are determined to be not optimal, which may cause a time delay to be introduced on one or more channels associated with the client device 142. The VPN server 212 may perform the decision to switch from no delay to an added delay that creates a set amount of time between each packet or a group of packets being sent to the client device 142. All subsequent data services used by the client device 142 for a particular application may be transmitted and received by the new server 212 with an introduced delay necessary to obfuscate latency and/or jitter values identified on one or more of the data channels.

When a new dataset associated with the VPN server 212, comprising one or more of the dataset elements including data rates experienced, latency rates, packet loss, jitter, etc., is compared to the known data metric threshold(s) and the new dataset data is identified as being less optimal than the previous dataset generated, then the VPN server 212 may introduce a delay for subsequent data usage. The AI decision making is based on baseline data over time for particular applications and for particular channels. All such baseline data is stored in memory 150 and may be re-evaluated periodically to select optimal time delay values used for transferring information to the client device 142.

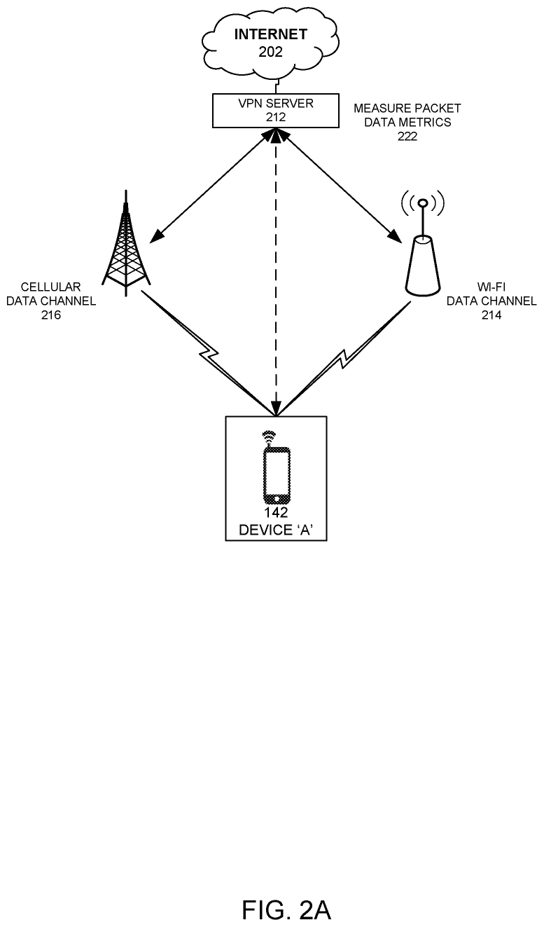

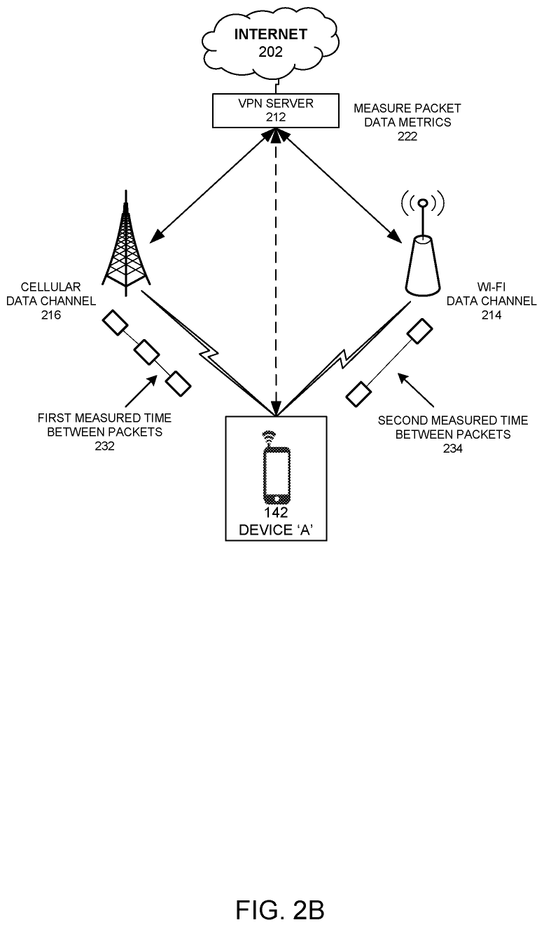

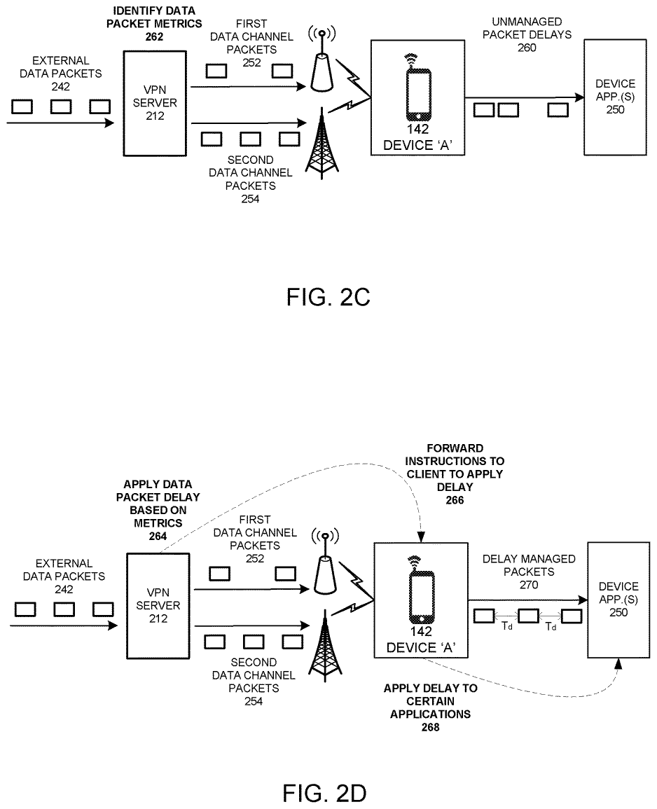

FIG. 2A illustrates a VPN server monitoring packet data metrics for a client device transmitting and receiving data according to example embodiments. Referring to FIG. 2A, the basic communication channel platform for a client device 142 using a VPN server 212 may include two or more channels. The example here provides a cellular data channel 216 being combined with a Wi-Fi data channel 214 to form a single logical connection of bonded channels which are managed by VPN server 212 and which can both be used to transmit and receive a common data stream. The data incoming for the device 142 may be from the Internet 202 and may be received by the VPN server 212 on behalf of the client device 142. The VPN server 212 may make the decision to bond the available channels 214 and 216 into a single bonded connection where unique packets will be sent on each channel for increased data throughput potential. The packet data metrics 222 may be measured to identify packet data characteristics associated with the client device 142.

Jitter is the variable time delay between packets received. The detected jitter can vary and cause problems for certain applications, such as real-time applications (e.g., voice, video, etc.). Jitter is an average value that is based on various latencies measured for packet data exchanges, referred to as round trip times (RTTs). A time delay applied to packets (static or dynamic) can be introduced as a way to buffer packets over a fixed time interval (static buffer) or a variable time interval (dynamic buffer) so that various packets are received and held in a buffer managed by the VPN server and/or a client managed packet buffer before being introduced to the destination server or end user device and used by corresponding applications which may use the packet data for a corresponding application. If the application used by the client device 142 is a real time type of application then the buffer permits packets to be released at a steady rate to conceal the delays and inconsistent times associated with when the packets are received.

In one example, a static time delay applied to packets may use a fixed delay time interval, such as 30, 50, ‘X’, milliseconds (ms), and any packets received and processed by the buffer will undergo an inevitable delay to create an overall end to end delay of ‘X’ ms regardless of the times the packets were received. A dynamic time delay applied to packets may increase and/or decrease the amount of delay by storing the packets received temporarily in an effort to provide a more fluid packet processing experience. A decision engine may predict what the jitter will be at the present time and in the future. The buffer can then increase or decrease the amount of delay introduced by queuing the packets in the buffer for a predetermined amount of time. A dynamic buffer could be used to cause an output data rate to change as well as an input rate.

With more than one channel available to a client device 142, channel bonding may seek to combine the plurality of channels to create a larger data throughput, reduce packet loss, and to create redundancy by switching between the channels to avoid errors and failed connections, etc. Introducing a time buffer to a set of bonded channels can create a new set of possibilities for a data rate optimization procedure.

FIG. 2B illustrates a VPN server identifying varying time delays for packet data of different data channels associated with a client device transmitting and receiving data according to example embodiments. Referring to FIG. 2B, the example illustration indicates that the two channels used by the mobile device in a single set of bonded connections may have varying packet delays. The average time between packets 232 received from the cellular channel 216 may be smaller than the average time window 234 between packets on the Wi-Fi channel. Since there are discrepancies in the time delays on different channels, which may be measured as latency (average time for a packet to travel to a destination and back to its starting point, or, from one point on a network to another) and/or jitter (variation in the delays between packets), and because one channel has larger time delays than the other channel, it may be prudent to buffer all packets via the VPN server 212 and introduce an acceptable delay, which will not interfere with application use by the client device 142, and while preserving continuity with the packet transfers to and/or from the client device 142. The time delay (T_{d}) used to balance the overall delays on both channels may be a constant time value used for all channels available to the client device. By introducing the delay and buffering packets at the VPN server 212 and/or at the client device 142, the flow of packets on all channels during a bonded channel session may be more continuous and may provide packets on all channels in a fixed delay window size.

FIG. 2C illustrates a VPN server transmitting and receiving various different packet data streams from various different data channels and identifying varying packet data metrics according to example embodiments. Referring to FIG. 2C, the example demonstrates how a VPN server 212 may receive packets 242 from an external source, such as a remote server across the Internet. The packets may be identified 262 as having certain data metrics, such as jitter, latency, loss rate, data rate, etc. The VPN server 212 may attempt to introduce a fixed delay in a download direction favoring the client device 142 and/or instruct the client device to introduce a delay based on what is identified from the data metrics. Once the packets are received by the VPN server 212, the packets may be forwarded across all channels as a bonded connection which includes a first channel with a first set of packets 252 and a second channel with a second set of packets 254. As may be observed, the time between packets may be arbitrary and uneven on a single channel or as compared from one channel to another channel. As a result, the device 142 may utilize applications 250 which are receiving packets at arbitrary and/or uneven and unmanaged time intervals 260. This may cause undesirable outcomes during application use, especially for real time sensitive applications, such as conferencing.

FIG. 2D illustrates a VPN server applying one or more time delays to various different packet data streams based on the identified packet data metrics according to example embodiments. Referring to FIG. 2D, the example includes managing data traffic in a single direction, such as the download direction with respect to the client device 142. Traffic may be managed and time delays may be introduced in any direction, such as download, upload, etc., by any device operating as part of the VPN. In this example, the VPN server 212 has identified data metrics associated with incoming data packets 242 in the download direction with respect to the client device 142. The metrics may include a minimum, maximum, average, etc., time delay between packets received. The decision to apply a delay 264 to a packet stream as it is introduced to one or more applications used by the client device 142 may be applied by the VPN server 212 and sent as an instruction 266 to the client device 142 which may delay the packets by a fixed time slot (T_{d}). The time delay may be applied 268 to all packets 270 forwarded to certain applications 250 used by the client device. The time delay may be applied to only certain data traffic sub-streams, such as those on a particular channel, used by a certain application etc. Other data streams may be left alone and the delays may continue to vary for those data streams.

In one example scenario, the client device 142 may be using one channel among two or more available channels to transmit and/or receive data. The VPN server 212 and/or the client device may introduce a time delay applied to data packets on a first channel prior to engaging a second channel in a bonded set of channels. In one example, the second channel may have more latency or jitter present than the first channel. If so, the time delay applied to packets can be introduced to appease the applications used by the client device to offset the inconsistent data packet delays between the two channels. This would result in a delay being introduced that is based on the larger delay observed between the two channels. Another scenario may include applying a time delay to packets for two or more channels having different latencies on the different channels. Introducing a single time delay applied to packets for both channels may effectively remove the latency of a single channel and balance both channels.

A measured difference between the latencies of the channels may enable a decision to be made as to how much delay to impose on the packet flow, and which channel(s) should be modified. If an application used by the client device 142 is more latency sensitive, then the amount of time delay introduced for each packet may be reviewed and mitigated over time as the metrics are evaluated and reevaluated. Also, a dynamic time delay scheme could be used to offset the latency without interfering with the application usage. An application may have an associated maximum delay sensitivity which may also be taken into consideration when applying a time delay.

The measured time delay between packets received on a single channel may be denoted by a first time delay value (T_{d1}), such as an average or common value identified as measured between each packet 252 transmitted or received on that first channel, and a second time delay (T_{d2}) may be identified as an average or common time value identified as measured between each packet 254 transmitted or received on a second channel used by a common client device 142. The average delay value may be 20 milliseconds (ms) on the first channel and the average delay value may be 70 ms on the second channel. In this case, the delay introduced by the device 142 using the packets for real time or near real time applications may introduce a delay of 80 or 100 ms for each packet received on either channel to create the delay managed packets 270. This approach may be necessary to ensure the packets are transferred to particular applications in a packet sequence that takes into consideration the measured jitter values on both channels and offers a delay that is larger than the delays being experienced on either channel.

The delay value for the packet stream 270 (T_{d}) may be at least as large as the larger latency and jitter values experienced on either of the two or more available channels. Ideally, a margin may be introduced to ensure the delay being used is large enough to manage the packets of both channels. In one example, if the delays are 30 ms and 70 ms on the respective channels, then the value of (Td) may be automatically set to 80 ms to ensure the delay is a value that is larger than the effective delays experienced by both channels. Once the value of the delay (Td) is selected for both channels, the packets that are received will be held in a temporary queue or buffer until they are released to the client device on all channels that provide the packets to the device and with the new time delay value as a basis for releasing each of the packets. The packets may then be applied to their respective applications for data consumption.

In another example, when two channels are available for use by the mobile device or client device, (e.g., Wi-Fi and cellular), the Wi-Fi channel may be used to send and receive packets and a delay in packet processing may be identified. A time delay applied to packets may be introduced with a set time window, such as a buffer or related time window mechanism. An analysis may be performed by the VPN server 212 and/or the client device 142 to determine whether there are any reductions in the latency of packets received over time. When the optimal metrics are identified, the second channel may be omitted from use and ignored or the second channel may be used but without any time delay introduced, such as the time delay recently used by the other channel. When there is no packet latency change measured, the channels may be bonded and used to transmit and receive packets without additional changes. Over time, the latency measurements may demonstrate packet latency changes requiring additional changes.

In another scenario, the VPN server may instruct the client device to use two or more channels to transmit and receive data and introduce a time delay applied to packets on one channel or both channels. A single time delay may be applied to packets on one channel to make the faster channel slower to match the slower channel. It may be prudent to introduce two or more channels to transmit and receive data and a single time delay to packets used by both channels. Another approach may be to use two or more channels to transmit and receive data and introduce a first time delay applied to packets on a first channel and a second time delay applied to packets on the second channel depending on the metrics of each channel. The first time delay and the second time delay may be different values which are customized for the specific channel to which they will be applied. Using a fixed window size for each independent time delay applied to each of the data packets received could assist with matching the connection packet data rates during a bonded session since a larger time window size on a faster channel could effectively match the slower connection with a smaller time window size. A commonly applied time delay for all bonded channels could balance all channels being used. Another approach is to assign the same delay to each packet on both channels. Even though one channel may provide faster packet transmissions and less latency than another channel, a same time delay may be introduced on both channels for the packets so that even though one packet may transmit faster on one channel vs. another channel, the overall delay will be the same due to the buffer.

In another example, when using two or more channels to transmit and receive data and introducing a static time delay (time delay does not change and stays constant) applied to packets on a first channel and a dynamic time delay (time delay which is subject to change over time) applied to packets on the second channel may provide a way to match two channels if one had a dynamic time delay applied to certain packets. The application of the time delays could be performed for each application and/or for each data flow of data packets. Examining packets to identify real time audio/video packets may enable the application of a certain time delay value to be applied to those packets or to not be applied. Each packet could be routed to a different queue and could be subject to a different time delay. The channels used in a current data session may be bonded, however certain packets may be prioritized for a certain channel or both channels and may be subject to certain time delays or no time delays. Another approach may be to use a static time delay on one channel and a dynamic time delay on another channel. Then, both channels may be switched to a same type of time delay for packets depending on monitoring operations.

Another approach may be to use two or more channels to transmit and receive data and introduce a first time delay on a first channel and a second time delay applied to packets on the second channel and removing one of the time delays applied to packets as data metric improvements are noted, such as reduced jitter, latency, packet loss, etc. Maintaining the time delay applied to packets may enable buffering of all packets, however, it may then be more optimal to have one buffer on one channel and no time delays on another channel when managing a set of bonded channels.

The time delay introduced to the packet transmission managed by the client device and/or the VPN server may be a consistent latency value applied to each packet. In general, the time windows between packet arrivals and departures are either delayed intentionally to match a larger time delay window observed from other packet flows on other channels, or are maintained and left alone. The time delays are introduced automatically based on the identified latency value, which may be an average of the packet delay times identified by one particular channel or a combination of multiple channels. In one example, a first channel (CH1) may have an average latency of 40 ms, and a second channel may have an average latency of 60 ms. The resulting latency assigned to all packets received by the VPN server may be 50 ms, 55 ms, or 60 ms depending on the anticipated application operating on the client device and which will consume those packets received at the client device.

In one example, the VPN server may receive packets from multiple channels. The VPN server may identify an application associated with the packets received. The application may be a time sensitive application. A machine learning model may retrieve information from memory indicating the application should operate at a target data rate which requires a target latency/delay value. The VPN server may then begin buffering the packets in a memory space and being releasing the packets to be sent to the client device based on a specifically assigned delay value that will provide a delay that is commensurate with the delays experienced by one or more channels (delay matching of the channel with the larger delay) and which accommodates the application being used on the client device which is anticipating those packets. Another delay selection and buffering strategy may be to identify the larger latency of two or more channels for packets received and assign that value as the delay value to the buffered packets so each packet is assigned that same packet delay for each of the channels used. Each channel will then forward packets to the client device from the data buffer based on the single assigned delay value.

Channel bonding may be performed to include two or more channels which share a common time delay for buffered packets. The connection may be relying on a single channel when another channel is made available and may be bonded with the first channel to create a set of bonded channels. The bonding operation may invoke a buffer operation to begin when the client device is experiencing a latency value that is not optimal for the currently operating application(s). The buffer time delay target may be identified as 50 ms based on the application being used or other historical criteria. There may be a plurality of available channels and the latency values may be 30, 40 and 60 ms. The target time delay may cause the channel with the highest latency (60 ms) to be avoided and the other two channels to be bonded since they can accommodate a 50 ms time delay.

Ideally, there would be a first channel and a second channel bonded for optimal data throughput. However, if the latency of the slower channel of the two channels is too large based on the estimated target delay value, which may be based on historical information or a current application being used by the client device, then another channel may be selected to replace the slower channel, if available, and assuming that new channel has a more optimal latency value that can accommodate the assigned delay value of the data buffer. As a result, the bonded channels may include one of the original channels and a new channel while the slower channel is omitted from the data connection used to transmit and receive data packets since that slower channel cannot accommodate the target delay value for managing data packets. When certain channels have different measured time delays, the packets from the faster channel(s) may arrive out of order relative to the slower channel. The packet delay buffer can be used not just to normalize timing but to resequence packets into correct application-layer order before delivery to the client device. The buffer may also assign sequence identifiers to the packets at the VPN server before transmission across bonded channels to the client device. Using the delay buffer to hold early-arriving packets until their correct sequence position is reached, the sequencing can provide another way to manage packet times while ensuring a correct sequence. The packets may be delivered to the application layer only when a contiguous packet sequence is confirmed within the buffer window. When channel bonding, a channel may be dropped from the set of bonded channels connection when a certain time delay falls below a target threshold. Similarly, a channel may be added and bonded when the time delay exceeds a target threshold delay value.

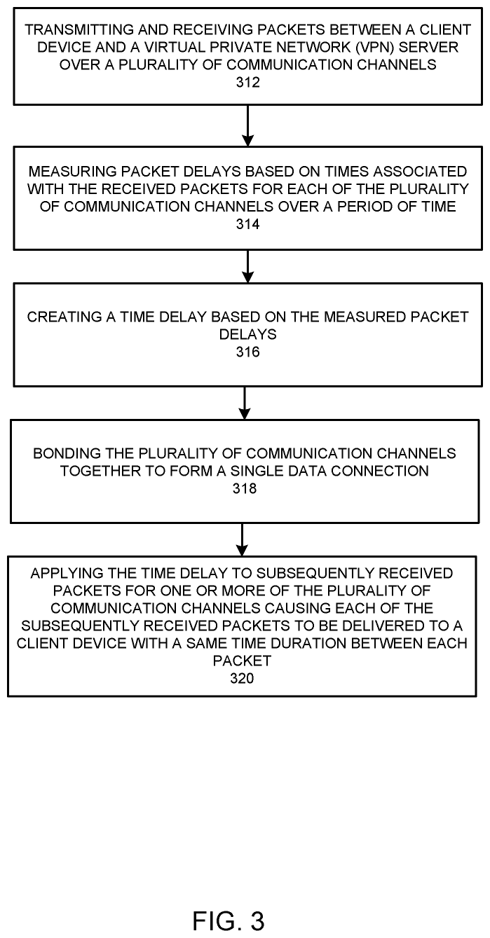

FIG. 3 illustrates an example flow diagram of an example data management process according to example embodiments. Referring to FIG. 3, the process may include transmitting and receiving packets between a client device and a virtual private network (VPN) server over a plurality of communication channels 312, measuring packet delays based on times associated with the received packets for each of the plurality of communication channels over a period of time 314, creating a time delay based on the measured packet delays 316, bonding the plurality of communication channels together to form a single data connection 318 and applying the time delay to subsequently received packets for one or more of the plurality of communication channels causing each of the subsequently received packets to be delivered to a client device with a same time duration between each packet 320.

The measured packet delays may be identified based on the times the packets are received at the client device. The time delays may also be based on a time sent, time received, time confirmed (RT), and times can be measured both directions. The measured packet delays may be identified based on the times the packets are received at the VPN server. The measured packet delays are larger on a first of the plurality of communication channels than the measured packet delays on a second of the plurality of communication channels. Larger is denoted as greater or larger in value than another value and smaller is smaller than something larger or lesser in value. Time, if larger, would be a greater value than a time that is smaller than the larger value. The process may include comparing the measured packet delays to a packet delay threshold, and when the packet delays on the first communication channel exceed the packet delay threshold, the process may include performing the bonding of the plurality of communication channels. The process may also include comparing the measured packet delays to a packet delay threshold, and when the packet delays on the first communication channel exceed the packet delay threshold, applying the time delay to subsequently received packets for the first communication channel. The process may also include comparing the measured packet delays to a packet delay threshold, and when the packet delays on the first communication channel exceed the packet delay threshold, applying the time delay to subsequently received packets for all of the bonded communication channels. The process may also include applying the time delay to the first communication channel for subsequently received packets, and applying a different time delay to the second communication channel for subsequently received packets, wherein the different time delay is smaller than the time delay. The process may further include, after a predetermined period of time, reducing the time delay to a smaller time delay and applying the reduced time delay to subsequently received packets for one or more of the plurality of communication channels. The process may further include determining whether the subsequently received packets exceed a packet delay threshold, and when the subsequently received packets exceed a packet delay threshold, increasing the time delay applied to the subsequently received packets for one or more of the plurality of communication channels. The process may further include determining whether the subsequently received packets exceed a packet delay threshold, and when the subsequently received packets exceed a packet delay threshold, increasing the time delay applied to the subsequently received packets for one or more of the plurality of communication channels.

The time delay may be applied to certain traffic, such as application specific data flows. For example, a time delay may be applied to a first data flow, and a second time delay may be applied to a second data flow. Depending on the data type, such as voice, streaming, non-real time data, each of those data types may have a selective time delay applied. Applying the time delay to multiple data flows and using different time delays may be an option for selective data flow management. Another approach may be excluding a channel with a latency that is too high by dropping a channel from the bonded channel group, another approach may be using application specific time restrictions and directing certain traffic to a particular channel, while a time delay is applied to the other channels. Different delays may be applied to different applications which are identified by IP address, port, traffic characteristics, domains, operating systems, etc. The application can notify the operating system about a differentiated services class by using tags or flags regarding IP packets, such as real time packets or other prioritized traffic. Routers may use data profiles to manage differing traffic types.

When a time delay becomes too large based on a threshold value, the channel can be excluded or the delay can be dropped back to a minimum value. The time delay applied to packets may use a jitter value that is based on the packet delays associated with the received packets and the time delay may be applied to packets of one or more channels used by the data connection. Certain applications used by the client device may initiate the time delay applied to packets.

Applications may be identified by an application name as one approach to identification. Domains accessed, ports and IP addresses could also be stored and referenced from a table to identify application types and purposes. Real time considerations, prioritization, and other criteria may be used for managing traffic. Packet flow analysis may be performed instead of merely auditing data flow parameters. The processing could rely on a volume of packets transmitted and/or received over a period of time to elevate the action taken to a time buffering scenario vs. a non-buffering scenario or a larger time buffer window scenario vs. a previous lower time buffer window currently active. Decisions could be made based on a particular application/flow, such as determining certain packets were lost, dropping packets, determining packets are important, elevating retransmission efforts, performing channel mirroring instead of standard bonding, etc. The retransmission effort could be alleviated by time buffering, and the time buffering may permit more time to switch from a first channel bonding scenario to another scenario to alleviate the time lost.

Prioritization may be used by examining one channel vs. another channel and selecting a channel that is optimal. The cellular channels, such as ultrawideband 5G, 5G, 4G, or Ethernet vs. Wi-Fi, data rate estimation and labeling could be used to select a channel. The IP address, the network card, network used before, a previous data rate, etc., could all be used as criteria for channel selection. Application names, domains, IP addresses and ports are known generally and could be stored in a table or database so assumptions can be made about the traffic and channels used.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

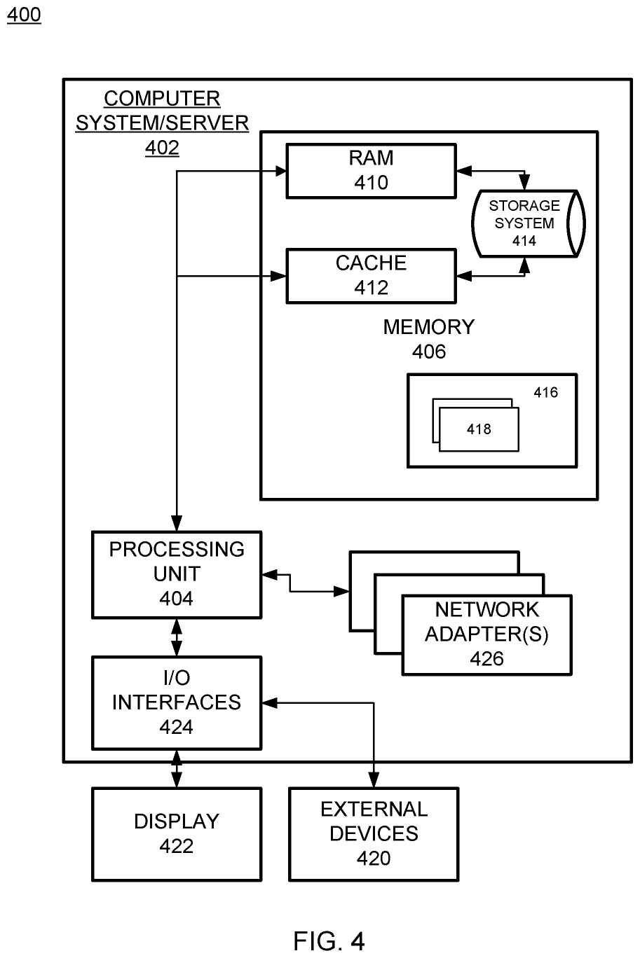

FIG. 4 illustrates an example network entity device configured to store instructions, software, and corresponding hardware for executing the same according to example embodiments. FIG. 4 is not intended to suggest any limitation as to the scope of use or functionality of embodiments of the application described herein. Regardless, the computing node 400 is capable of being implemented and/or performing any of the functionality set forth hereinabove.

In computing node 400 there is a computer system/server 402, which is operational with numerous other general purpose or special purpose computing system environments or configurations. Examples of well-known computing systems, environments, and/or configurations that may be suitable for use with computer system/server 402 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 402 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 402 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 4, computer system/server 402 in cloud computing node 400 is displayed in the form of a general-purpose computing device. The components of computer system/server 402 may include, but are not limited to, one or more processors or processing units 404, a system memory 406, and a bus that couples various system components including system memory 406 to processor 404.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 402 typically includes a variety of computer system readable media. Such media may be any available media that is accessible by computer system/server 402, and it includes both volatile and non-volatile media, removable and non-removable media. System memory 406, in one embodiment, implements the flow diagrams of the other figures. The system memory 406 can include computer system readable media in the form of volatile memory, such as random-access memory (RAM) 410 and/or cache memory 412. Computer system/server 402 may further include other removable/non-removable, volatile/non-volatile computer system storage media. By way of example only, storage system 414 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 406 may include at least one program product having a set (e.g., at least one) of program modules that are configured to carry out the functions of various embodiments of the application.

Program/utility 416, having a set (at least one) of program modules 418, may be stored in memory 406 by way of example, and not limitation, as well as an operating system, one or more application programs, other program modules, and program data. Each of the operating system, one or more application programs, other program modules, and program data or some combination thereof, may include an implementation of a networking environment. Program modules 418 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 402 may also communicate with one or more external devices 420 such as a keyboard, a pointing device, a display 422, etc. ; one or more devices that enable a user to interact with computer system/server 402; and/or any devices (e.g., network card, modem, etc.) that enable computer system/server 402 to communicate with one or more other computing devices. Such communication can occur via I/O interfaces 424. Still yet, computer system/server 402 can communicate with one or more networks such as a local area network (LAN), a general wide area network (WAN), and/or a public network (e.g., the Internet) via network adapter(s) 426. As depicted, network adapter(s) 426 communicates with the other components of computer system/server 402 via a bus. It should be understood that although not displayed, other hardware and/or software components could be used in conjunction with computer system/server 402. Examples include, but are not limited to: microcode, device drivers, redundant processing units, external disk drive arrays, RAID systems, tape drives, and data archival storage systems, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
transmitting and receiving packets between a client device and a virtual private network (VPN) server over a plurality of communication channels;
measuring packet delays based on times associated with the received packets for each of the plurality of communication channels over a period of time;
creating a time delay based on the measured packet delays;
bonding the plurality of communication channels together to form a single data connection; and
applying the time delay to subsequently received packets for one or more of the plurality of communication channels causing each of the subsequently received packets to be delivered to a client device with a same time duration between each packet.

2. The method of claim 1, wherein the measured packet delays are identified based on the times the packets are received at the client device.

3. The method of claim 1, wherein the measured packet delays are identified based on the times the packets are received at the VPN server.

4. The method of claim 1, wherein the measured packet delays are larger on a first of the plurality of communication channels than the measured packet delays on a second of the plurality of communication channels.

5. The method of claim 4, comprising
comparing the measured packet delays to a packet delay threshold; and
when the packet delays on the first communication channel exceed the packet delay threshold, performing the bonding of the plurality of communication channels.

6. The method of claim 4, comprising
comparing the measured packet delays to a packet delay threshold; and
when the packet delays on the first communication channel exceed the packet delay threshold, applying the time delay to subsequently received packets for the first communication channel.

7. The method of claim 4, comprising
comparing the measured packet delays to a packet delay threshold;
when the packet delays on the first communication channel exceed the packet delay threshold, applying the time delay to subsequently received packets for all of the bonded communication channels.

8. The method of claim 4, comprising
applying the time delay to the first communication channel for subsequently received packets; and
applying a different time delay to the second communication channel for subsequently received packets, wherein the different time delay is smaller than the time delay.

9. The method of claim 1, comprising
after a predetermined period of time, reducing the time delay to a smaller time delay and applying the reduced time delay to subsequently received packets for one or more of the plurality of communication channels.

10. The method of claim 9, comprising
determining whether the subsequently received packets exceed a packet delay threshold; and
when the subsequently received packets exceed a packet delay threshold, increasing the time delay applied to the subsequently received packets for one or more of the plurality of communication channels.

11. The method of claim 1, comprising
determining whether the subsequently received packets exceed a packet delay threshold; and
when the subsequently received packets exceed a packet delay threshold, increasing the time delay applied to the subsequently received packets for one or more of the plurality of communication channels.

12. An apparatus comprising:
a processor configured to
transmit and receive packets associated with a virtual private network (VPN) server over a plurality of communication channels;
measure packet delays based on times associated with the received packets for each of the plurality of communication channels over a period of time;
create a time delay based on the measured packet delays;
bond the plurality of communication channels together to form a single data connection; and
apply the time delay to subsequently received packets for one or more of the plurality of communication channels causing each of the subsequently received packets to be delivered with a same time duration between each packet.

13. The apparatus of claim 12, wherein the measured packet delays are identified based on the times the packets are received.

14. The apparatus of claim 12, wherein the measured packet delays are larger on a first of the plurality of communication channels than the measured packet delays on a second of the plurality of communication channels.

15. The apparatus of claim 14, wherein the processor is further configured to
compare the measured packet delays to a packet delay threshold; and
when the packet delays on the first communication channel exceed the packet delay threshold, perform the bonding of the plurality of communication channels.

16. The apparatus of claim 15, wherein the processor is further configured to
compare the measured packet delays to a packet delay threshold; and
when the packet delays on the first communication channel exceed the packet delay threshold, apply the time delay to subsequently received packets for the first communication channel.

17. A non-transitory computer readable storage medium configured to store instructions that when executed cause a processor to perform:
transmitting and receiving packets between a client device and a virtual private network (VPN) server over a plurality of communication channels;
measuring packet delays based on times associated with the received packets for each of the plurality of communication channels over a period of time;
creating a time delay based on the measured packet delays;
bonding the plurality of communication channels together to form a single data connection; and
applying the time delay to subsequently received packets for one or more of the plurality of communication channels causing each of the subsequently received packets to be delivered to a client device with a same time duration between each packet.

18. The non-transitory computer readable storage medium of claim 17, wherein the measured packet delays are identified based on the times the packets are received at the client device.

19. The non-transitory computer readable storage medium of claim 17, wherein the measured packet delays are identified based on the times the packets are received at the VPN server.

20. The non-transitory computer readable storage medium of claim 19, wherein the processor is further configured to perform:
comparing the measured packet delays to a packet delay threshold; and
when the packet delays on the first communication channel exceed the packet delay threshold, performing the bonding of the plurality of communication channels.
